(19) United States
(12) Patent Application Publication
(10) Pub. No.: US 2013/0110802 A1
(43) Pub. Date: May 2, 2013

(54) CONTEXT AWARE TAGGING INTERFACE

(71) Applicants: RAJESH KRISHNA SHENOY, SAN JOSE, CA (US); CHARLES C. CARSON, JR., CUPERTINO, CA (US); YI-AN LIN, SUNNYVALE, CA (US); TIMOTHY ANDREW HARRINGTON, MOUNTAIN VIEW, CA (US); SAMEER INDARAPU, MOUNTAIN VIEW, CA (US)

(72) Inventors: RAJESH KRISHNA SHENOY, SAN JOSE, CA (US); CHARLES C. CARSON, JR., CUPERTINO, CA (US); YI-AN LIN, SUNNYVALE, CA (US); TIMOTHY ANDREW HARRINGTON, MOUNTAIN VIEW, CA (US); SAMEER INDARAPU, MOUNTAIN VIEW, CA (US)

(73) Assignee: MICROSOFT CORPORATION, REDMOND, WA (US)

(21) Appl. No.: 13/282,001

(22) Filed: Oct. 26, 2011

(51) Int. Cl. G06F 17/30

(52) U.S. Cl. 707/706; 707/722; 707/E17.014; 707/E17.108

(57) ABSTRACT

Systems, methods, and computer-readable storage media for tagging uniform resource locators (URLs) included in a search engine results page are provided. Upon receipt of a search query that includes a name of an entity, the server device provides search results and entry fields to tag one or more URLs that correspond to the entity. The server device obtains a social network of the user that provided the query. The server device processes the social network to locate entities that match the query and that are within a threshold number of hops. The user may tag one or more URLs with social network account information for the entities based on authorization information received from an owner that manages the social network account.

### BACKGROUND

The Internet, through its billions of Web pages, provides a vast and quickly growing library of information and resources. In order to find desired content, computer users often make use of search engines to query an index for one or more search terms. The computer users provide search terms to a search engine, which returns results that refer to the Web pages and other electronic content that match the search terms. Unfortunately, a significant set of search terms received from the users are ambiguous. Typical examples are search terms that include names, e.g., “John Smith.”

A user may transmit a person search query to a conventional search engine, which locates content that contains information about search terms included in the search query. For instance, a search query for “John Smith” that is received by the conventional search engine is parsed into the search terms: “John” and “Smith” or “John” or “Smith.” The conventional search engines then perform searches of the index for each of the search terms: “John” and “Smith.” The results from the index that match the terms are provided to the user. However, the conventional search engine is unable to distinguish between multiple individuals within the search results that have the same name.

Some conventional search engines refine the results via query modifiers that are suggested to the user or obtained from the context of the user. For instance, location information associated with an Internet Protocol (IP) address of the user may be used to narrow the results size by removing results that fail to match the location of the user. The conventional search engines may utilize other modifiers, e.g., prior search histories from the user or other users, to narrow the size of the results. The prior search histories included in a search log of the database may be analyzed by the conventional search engine. The search log may include modifiers that were previously used by the user or other searchers when searching for “John Smith.” The conventional search engine extracts the modifiers from the search log and presents them to the user as query modifiers that may narrow the size of results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the invention relate to systems, methods, and computer-readable storage media for, among other things, identifying social network connections in a search engine results page received in response to a query from a user. The search engine is configured to provide tagging interfaces that allow the user to identify results that are related to entities in the social network of the user. Upon receipt of a search query, a search engine is configured to determine whether the query, or a portion thereof, is a name query. In response to the name query, a tagging interface is presented to the user. The tagging interface allows the user to specify the social network of the user. In some embodiments, the tagging interface allows the user to identify URLs that are related to entities included in the social network of the user.

The search engine, in one embodiment, may obtain the social network of the user and compare the name query to information included in the social network to determine whether there is a match to the query. If it is determined that one or more entities in the social network matches the name query, the social network identifier or some other identifier is utilized as a tag for the one or more entities. The user may mark one or more URLs with the identifier when the user determines that the content associated with the URL is related to the entity associated with the identifier. In turn, the tags may be stored in a database accessible by the search engine based on permissions established by entities tagged by the user. In some embodiments, the entities that are tagged by the user may receive notifications to inform the entities that a user has associated one or more URLs with their identifiers.

### BRIEF DESCRIPTION OF THE DRAWINGS

The embodiments of the innovative technology are illustrated by way of example and not limited in the accompanying figures, which are incorporated herein by reference, in which like reference numerals indicate similar elements and in which:

FIG. 1 is a network diagram of an exemplary computing environment suitable for use in implementing embodiments of the invention;

FIG. 2 is a logic diagram that illustrates an exemplary method for providing tags for search results in accordance with embodiments of the invention;

FIG. 3 is a state diagram that illustrates some exemplary states of the search engine in accordance with an embodiment of the invention;

FIG. 4 is a logic diagram that illustrates an exemplary method to tag entities included in search engine result pages in accordance with embodiments of the invention;

FIG. 5 is a logic diagram that illustrates an exemplary method for providing tags for URLs in the search results page, where the URLs are related to the searcher in accordance with embodiments of the invention;

FIG. 6 is a schematic diagram that illustrates an exemplary graphical user interface with tag elements of a search engine results page, in accordance with an embodiment of the invention;

FIG. 7 is a schematic diagram that illustrates an exemplary graphical user interface having tag functionality for URLs in the search engine results page, in accordance with an embodiment of the invention;

FIG. 8 is a schematic diagram that illustrates an exemplary graphical user interface having functionality to request permission to access a social network, in accordance with an embodiment of the invention;

FIG. 9 is a schematic diagram that illustrates an exemplary graphical user interface having functionality to provide tag suggestions based on partial tags, in accordance with an embodiment of the invention;

FIG. 10 is a schematic diagram that illustrates an exemplary graphical user interface having search results and clusters associated with tagged results, in accordance with an embodiment of the invention;

FIG. 11 is a schematic diagram that illustrates an exemplary graphical user interface having search results for the searcher, in accordance with an embodiment of the invention;

FIG. 12 is a schematic diagram that illustrates an exemplary graphical user interface having search results for the searcher and other entities with a similar name, in accordance with an embodiment of the invention;

FIG. 13 is a schematic diagram that illustrates an exemplary graphical user interface having removable tags in the search results, in accordance with an embodiment of the invention;

FIG. 14 is a schematic diagram that illustrates an exemplary graphical user interface having permission status for tags in the search results, in accordance with an embodiment of the invention;

FIG. 15 is a schematic diagram that illustrates another exemplary graphical user interface having removable tags in the search results, in accordance with an embodiment of the invention;

FIG. 16 is a schematic diagram that illustrates an exemplary graphical user interface having social network profile information associated with a tagged search result, in accordance with an embodiment of the invention;

FIG. 17 is a schematic diagram that illustrates an exemplary graphical user interface having taggable search results for the searcher, in accordance with an embodiment of the invention;

FIG. 18 is a schematic diagram that illustrates an exemplary graphical user interface having an approval dialog to approve a tag, in accordance with an embodiment of the invention;

FIG. 19 is a schematic diagram that illustrates an exemplary graphical user interface having an approval dialog for tags entered by the searcher, in accordance with an embodiment of the invention;

FIG. 20 is a schematic diagram that illustrates another exemplary graphical user interface having a permission dialog to access a social network of the searcher, in accordance with an embodiment of the invention;

FIG. 21 is a schematic diagram that illustrates another exemplary graphical user interface having an approval dialog for tags entered by the searcher, in accordance with an embodiment of the invention;

FIG. 22 is a schematic diagram that illustrates another exemplary graphical user interface having a tagged search result, in accordance with an embodiment of the invention;

FIG. 23 is a schematic diagram that illustrates an exemplary graphical user interface without tagged search results, in accordance with an embodiment of the invention;

FIG. 24 is a schematic diagram that illustrates another exemplary graphical user interface having a result for the logged-in searcher, in accordance with an embodiment of the invention;

FIG. 25 is a schematic diagram that illustrates another exemplary graphical user interface having a feed in a social network application associated with a searcher, in accordance with an embodiment of the invention; and

FIG. 26 is a block diagram that illustrates an exemplary computer in accordance with embodiments of the invention.

### DETAILED DESCRIPTION

The subject matter of this patent is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to computer systems, computer-implemented methods, and computer-readable storage media for, among other things, presenting social network connections in association with a search engine results page. Embodiments of the invention allow users to quickly identify URLs in a search engine results page that are related to the users or entities in the social network of the user. A search engine receives queries, e.g., name queries, from the users. The search engine returns URLs that match the queries to the users.

In one embodiment, a tagging interface is included in a search engine results page when the search engine determines that the queries are ambiguous. For instance, the search engine may check search logs and click-throughs. When the click-throughs are sporadic and not centered around a particular URL or group of URLs, the search engine flags the query as ambiguous. For instance, when search engine determines that the percentage of the click distribution for a query associated with two or more URLs having a click percentage that is at or less than 50%, the search engine flags the query as ambiguous. The search engine analyzes the logs and clicks to determine that the query is ambiguous because URLs that are clicked on are very different. Alternatively the query may identified as ambiguous if the query is a person's name, or contains a person's name, then it is likely to be ambiguous. But the search engine may not consider celebrity names (actors, singers, etc.) include in the query to be ambiguous. If the query is an acronym (e.g., SIGIR or ACM), then it is identified as ambiguous. If the prior results for the query come from different categories of sites (e.g. “jaguars” yields results about cars, animals, and a sports team), then the query is identified as ambiguous. If the prior results for the query contain several different URLs from a specific social network, then query is identified as ambiguous. The tagging interface is made available to user when the search engine identifies the query as ambiguous. The tagging interface allows the user to tag results having content associated with an entity in the social network of the user. Accordingly, the search engine results page may include tagging interfaces when a query received from the user is flagged as ambiguous.

The tagging interface in the search engine results page is triggered based on contextual information of the searcher and the query. The tagging interface allows the users to tag results on the search engine results page if the URLs are about the entity the user is trying to obtain results for. In some embodiments, the results may be tagged with identifiers for friends of the user. The identifiers may be the social network identifiers or be based on the social network identifiers utilized by the friends of the user. The identifier may be a hash of the social network identifier of the entity. The users and their friends—who may be found through a social network—are allowed to tag specific URLs related to the queries entered by the users or the friends. The tags correspond to the URLs having content about the entity that is indicated in the query. These tags may be utilized by the search engine, when a subsequent query for the same name is identified as ambiguous, to identify relevant tagged URLs associated with the matching entities in the social network of the user for display to the user.

In yet another embodiment, the tags may be associated with a URL based on permissions identified by the tagger and the taggee. The tagger is the person pairing tags and URLs. The taggee is the entity associated with the tag. The search engine utilizes the permissions to determine whether to approve or reject one or more tag-URL pairing received from the user. For instance, a tag may correspond to a social network identifier. A user may click or hover over a tag to determine whether approval is required. In one embodiment, the taggee may specify permissions that prohibit use of its social network information. The taggee may also indicate whether the tags are private or public. When the tags are private, only individuals in the tagger's social network may see the tags in a search engine results page. When the tags are public, in one embodiment, any user that submits a query for a name matching the taggee's tag may see the tags and URLs in the search engine results page.

Accordingly, embodiments of the invention encourage tagging of URLs in a search engine results page and sharing of tagged search results to others, including entities in a social network of the tagger and taggee. Based on the URLs returned to the query, the users may tag URLs associated with content about themselves or tag URLs associated with content about their friends.

As one skilled in the art will appreciate, the computer system configured to implement the embodiments of the invention may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In yet another embodiment, the computer system includes a communication network having an index, social network providers, client computers, and a search engine. The index is configured to store URLs for content located on the Internet. A user may generate a query at the computer, which is communicatively connected to the search engine. In turn, the computer may transmit the query to the search engine. The search engine may use the query to locate URLs, in the index, having content that matches the query. The search engine may provide the URLs in a search engine results page, which may include a tagging interface if the query is identified as ambiguous by the search engine.

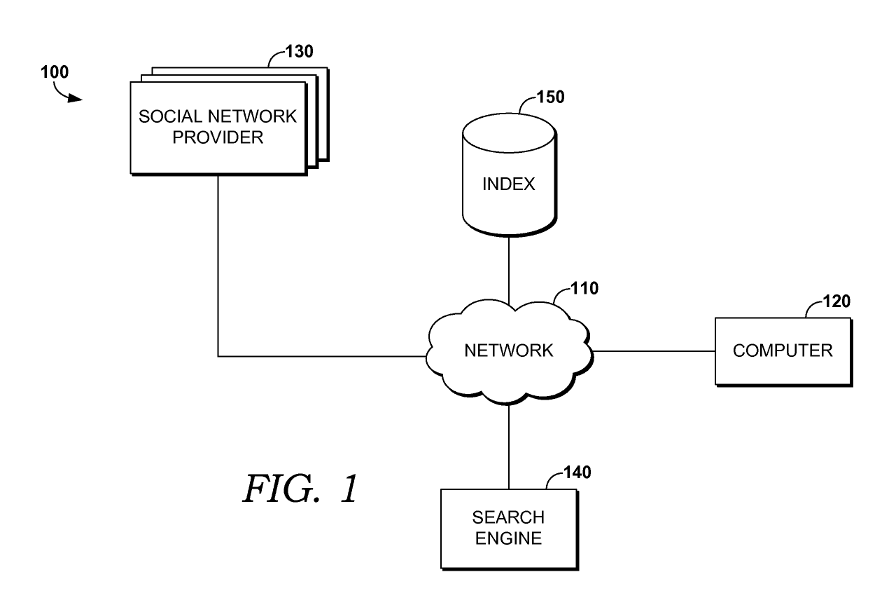

FIG. 1 is a network diagram that illustrates an exemplary computing system 100 in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a network 110, computer 120, social network provider 130, search engine 140, and index 150.

The network 110 enables communication among the various network devices and resources. The network 110 connects computer 120 and search engine 140. The social network provider 130 and index 150 are also connected to network 110. The network 110 is configured to facilitate communication between the computer 120 and the search engine 140. It also enables the search engine 140 to access the social network provider 130 to exchange information based on URLs in a search engine results page and tags identified by the user. The network 110 may be a communication network, such as a wireless network, local area network, wired network, or the Internet. In an embodiment, the computer 120 interacts with the search engine 140 utilizing the network 110. For instance, a user of the computer 120 may generate a query, like a name query. In response, the search engine 140 interrogates the index 150 for URLs that include web pages, images, videos, or other electronic documents that match the query generated by the user.

The computer 120 allows the user to view a search engine results page received from the search engine 140. In some embodiments, the search engine results page includes a tagging interface. The computer 120 may allow the user to enter tags for URLs included in the search engine results page. The computer 120 is connected to the search engine 140 via network 110. The computer 120 is utilized by a user to generate search terms, to hover over objects, or to select links or objects, and to receive search engine results pages or web pages that are relevant to the search terms, the selected links, or the selected objects. The computer 120 includes, without limitation, personal digital assistants, smart phones, laptops, personal computers, gaming systems, set-top boxes, or any other suitable client computing device. The computer 120 includes user and system information storage to store user and system information on the computer 120. The user information may include search histories, cookies, and passwords. The system information may include Internet Protocol addresses, cached web pages, and system utilization. The computer 120 communicates with the search engine 140 to receive the search results or web pages that are relevant to the search terms, the selected links, or the selected objects. The computer 120 may communicate with a social network provider 130 to receive social network alerts or profiles associated with entities tagged by the user or social network alerts or profiles associated with the user.

The social network provider 130 receives requests for social network data, generates responses to the requests for social network data, and receives notifications from a search engine. The notifications may be generated in response to tags received from the user that submitted a query to the search engine. The social network information may be stored in a database accessible by the social network provider 130. In other embodiments, the social network information may be stored in a cache of the search engine 140 to optimize performance of the search engine. In some embodiments, the social network provider 130 may be a server device that is connected to network 110, index 150, and computer 120.

The search engine 140 is utilized to traverse the index 150 and generate a search engine results page in response to a search request, including name queries. The search engine 140 is communicatively connected via network 110 to the computer 120. The search engine 140 is also connected to index 150 and the social network provider 130. In certain embodiments, the search engine 140 is a server device that generates graphical user interfaces, including tagging interfaces when appropriate, for display on the computer 120. The search engine 140 receives, over network 110, selections of words or selections of links from computer 120 that renders the interfaces that receive interactions from users.

In certain embodiments, the search engine 140 may parse a query to determine whether a tagging interface should be generated for display to the user. If the query is identified as ambiguous by the search engine 140, the tagging interface is generated by the search engine 140 and transmitted to the computer 120 for display to the user. If the query is not identified as ambiguous by the search engine 140, the tagging interface, in one embodiment, is not generated. In other embodiments, the tagging interface is generated for both ambiguous and nonambiguous queries. In an alternate embodiment, the search engine 140 may generate a notification to inform the user that tagging functionality may be utilized on the URLS within the search results page.

For instance, if the terms of the query are “Harry Shum Asian Exec Award” the search engine 140 may not identify this query as ambiguous. So, the search engine 140 may not generate the tagging interface. However, the search engine 140 may generate a notification to inform the user that URLs within the search results may be tagged. The notification may be a message that informs the user that URLs about himself may be tagged. Alternatively, the notification may be a URL to the tagging interface or a tagged result. If the notification is a tagged URL, the URL may be selected from among the top URLs included in the search engine results page.

In certain embodiments, the search engine 140 may transmit the query to the index 150. The search engine 140 utilizes the query to identify URLs that match. In turn, the search engine 140 examines the matches and provides the computer 120 a set of uniform resource locators (URLs) that point to web pages, images, videos, or other electronic documents in the search engine results page. The search engine results page may include a tagging interface that allows the user to tag the URLs. In some embodiments, the user opts-in to allow the search engine to access his/her social network to obtain social network identifiers that may be utilized as tags. In certain embodiments, the search engine 140 prevents a tagger from associating offensive URLs, e.g., porn, malware, or any other inappropriate content with the tags.

The index 150 stores words and a posting list. The words are typically associated with electronic documents like, web pages, videos, text files, and images. The posting list allows the user to identify the documents associated with the words. In some embodiments, the index 150 also stores tags received from the user. In other embodiments, the tags are stored in a separate storage database connected to the index 150. The tags may be utilized by the search engine 140 when responding to subsequent queries for URLs associated with a tagged entity. Additionally, the database may store the date and time the tags are associated with the URL, the tag-URL pairings, and permissions associated with a tagger or taggee. The permissions may include require approval, automatically approve, no tagging by anyone, or no tagging by specifically identified entities. The require approval permission prevents the database from committing to storage a tag-URL pairing without first receiving authorization from the taggee via the search engine. The automatically approve permission allows the database to commit to storage a tag-URL pairing without first receiving authorization from the taggee. The no tagging by anyone permission prevents the database from committing to storage a tag-URL pairing received from anyone except the entity associated with the tag. The no tagging by specifically indentified entities permission prevents the database from committing to storage a tag-URL pairing received from the specifically identified entities. In some embodiments, preventing the database from committing to storage a tag-URL pairing, includes storing the tag-URL pairing and flagging the tag-URL pairing to indicate that authorization or approval is required before the tag-URL pairing is committed.

Accordingly, the computing system 100 is configured with a search engine 140 that provides results that include URLs and a tagging interface to the computer 120. The search request received from the computer 120 is received by the search engine, which traverses the index 150 to obtain results, including available tagged results. The search engine transmits the results to the computer 120. In turn, the computer 120 renders the results for the users.

The tagging interface is included with or in the search engine results page transmitted to the user. In some embodiments, the search engine may obtain permission from the user to access the social network of the user before utilizing the social network identifiers as tags for URLs included in the search results. In other embodiments, the search engine utilizes a hash of the social network identifier as a tag. If the user does not allow the search engine to access its social network, the search engine, in at least one embodiment, may limit the user's access to results tagged by the entities in the social network of the user or other entities outside of the social network of the user.

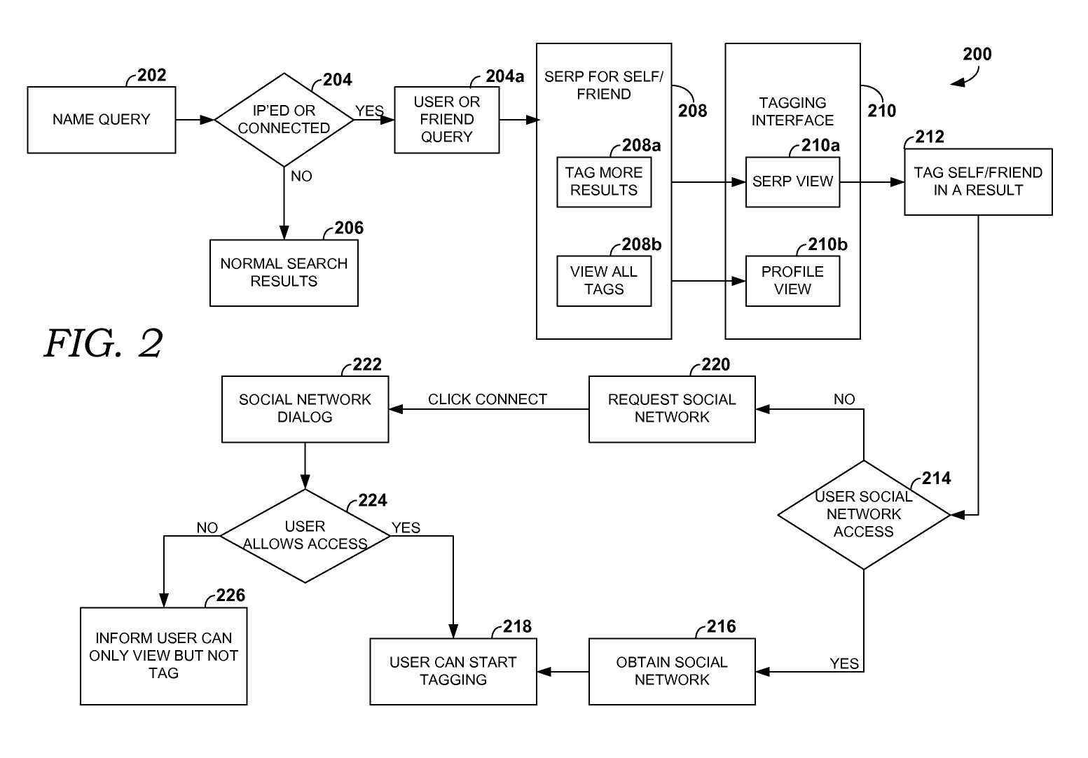

FIG. 2 is a logic diagram that illustrates an exemplary method 200 for providing tags for search results in accordance with embodiments of the invention. The method is initialized when the search engine receives a query. In one embodiment, the query received by the search engine is checked, in step 202, to determine whether a name is contained in query. When the query contains a name, the search engine, in step 204, confirms that access to the social network of the user is available. In turn, the search engine determines whether the name contained in the query matches the user or a friend of the user included in the social network, in step 204. In certain embodiments, specific Internet Protocol (IP) addresses may be associated with users that have authorized access to their social network and are included in the session information. In another embodiment, the session information may include an indication that the user has authorized access to the user's social network.

If the user has not authorized access, in step 206, the search engine returns URLs in a search engine results page that matches the query. These are normal search results and may not include tags. If the user has authorized access and the query contains a name of the friend or user, in step 208, the search engine returns the URLs in the search results page and a tagging interface to tag URLs. The tagging interface allows the user to tag entities (friends, siblings, parents, colleagues) included in the social network of the user. In step 208a, the user may enter tags for the URLs. In step 208b, the user may request to view all URLs for a specific tag or view all tags that are entered by the user. In step 210, the tagging interface is updated based on the tags received from the user. In step 210a, the search engine results page is updated to include the tags entered by the user. In one embodiment, the tags may be represented by a thumbnail associated with an entity in the social network. In step 210b, the tagging interface may be updated with a profile view for a friend or the user. The profile view may include social networking information and URLs tagged for the friend or the user.

In step 212, the search engine receives the tags entered by the user. The search engine may be configured to store the tags in an index utilized to locate the URLs that matched the query. In some embodiments, the search engine may check permissions associated with the user's social network before updating the index. In step 214, the search engine verifies that access to the social network is available. If access to the social network is available, the search engine obtains the social network of the user, in step 216. In turn, the tags are stored in the index, in step 218. If access to the social network is unavailable, the search engine requests that the user identify a social network, in step 220. In step 222, the user may provide authorization information to access the social network. In step 224, the search engine determines whether the user allows the social network to be accessed. If the user disallows access, in step 226, the search engine generates a notification message informing the user. In one embodiment, the message may inform the user that it can only view tags and not enter them. If the user allows access, the tags received from the user are stored in step 218. The stored tags may be utilized to respond to subsequent queries.

The search engine may operate in multiple states. The states include, among other states, receiving search queries, providing tagging interfaces, and viewing results. The search engine may move from one state to another based on the input received from the user, index, or social network provider or any other computer system.

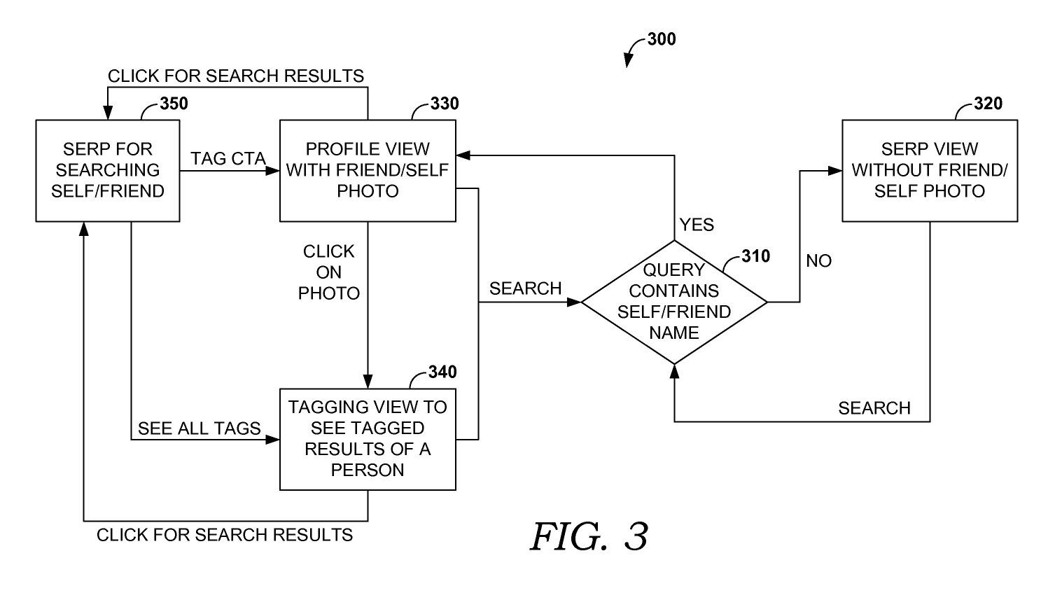

FIG. 3 is a state diagram 300 that illustrates some exemplary states of the search engine in accordance with an embodiment of the invention. In state 310 the search engine determines whether a query has a name for the user or a friend. The search engine may check a social network of the user for matches to the query. If the search engine does not locate a match or the query is not a name, the search engine moves to state 320. In state 320, the search engine generates a search engine results page without any information for the social network of the user. For instance, the search results page would not include any information or images of the user or entities included in the social network of the user.

If the search engine locates a match, the search engine moves to state 330. In state 330, the search engine may obtain profile information, including a social network identifier or photograph of the matching entities. The search engine may provide the user with a profile view of the potential matches. The profile view may include the social network identifier or photograph. The tags utilized by the user for the URLs of the search engine results page may be based on the information included in the profile view.

If the search engine receives an indication that the user is clicking on the photograph or tag associated with the URL, the search engine may move to state 340, where the user is provided with a view of the tagged URLs associated with the entity linked to the photograph or tag. In some embodiments, the user may update the query and issue a new search request, while in profile view state 330 or tagging view state 340. This may cause the search engine to return to state 310 discussed above.

In turn, the user may click on a link to return to the search engine results page. This causes the search engine to move to state 350. In state 350, the user may continue viewing URLs that may be tagged and associated with an entity in the user's social network. In one embodiment, the user may select tags for URLs based on the content of the URL and the social network profile information available to the user. This may cause the search engine to move from state 350 to state 330 discussed above. In other embodiments, the user may view tags for a specific entity to review the URLs associated with the entity or to tag additional URLs. This may cause the search engine to move from state 350 to state 340 discussed above.

In one embodiment, a computer-implemented method is executed by a server device of the search engine to tag URLs in the search results page. Upon receipt of a search query that includes a name of an entity, the server device provides search results and entry fields to tag one or more URLs that correspond to the entity. The server device obtains a social network of the user that provided the query. The server device processes the social network to locate entities that match the query and that are within a threshold number of hops. The user may tag one or more URLs with social network account information for the entities based on authorization information received from an owner that manages the social network account.

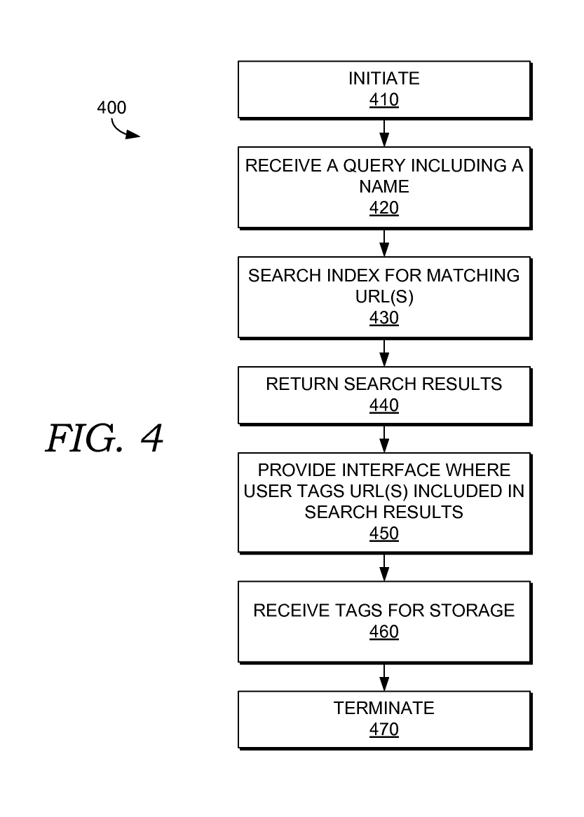

FIG. 4 is a logic diagram that illustrates an exemplary method to tag entities included in search engine result pages in accordance with embodiments of the invention. The method initializes in step 410. In step 420, a server device executing the search engine receives a query that includes a name of an entity. In step 430, the server device searches an index to locate URLs associated with content that matches the name. In step 440, the server device returns search results that include the name. In step 450, the server device provides an interface where the user enters tags for one or more URLs included in the search engine results page. The tags may be associated with social network identifiers for entities included in the social network of the user.

In one embodiment, the tags are based on, or limited to, the user's social network. The server device obtains a graph representing the social network of the user that provided the query. In turn, the server device locates entities in the social network that are within a threshold number of hops. The server device provides the located entities as suggested tags for the one or more URLs included in the search engine results page. In certain embodiments, the threshold number of hops is three.

In some embodiments, notifications are generated for one or more social network accounts associated with the entities identified by the tags entered by the user for the one or more URLs. The notifications are transmitted to the one or more social network accounts by the server device. The notifications may include requests to obtain permission from the entities associated with the tags corresponding to the one or more URLs. Also, the notifications may allow the owners of the social network accounts to authorize the tags or to remove the tags.

In turn, in step 460 the server device receives the tags entered in the interface for storage in a database connected to the index. The tags may identify entities in a social network of the user that provided the query. The server device may update the database to include the URL-tag pairs received from the user. Thus, subsequent queries for a tagged entity return the search results that match the subsequent query and a cluster having the URLs that are tagged by the user or other searchers. The clusters may include profile information provided by the social network account of the tagged entity or the user. In some embodiments, the cluster is a link that is shareable on the social network application via a broadcast feed. In other embodiments, the link is an image retrieved from the social network account corresponding to the tags. The method terminates in step 470.

In some embodiments, the user may directly navigate to the tagging interface before providing a search query. In this instance, the search engine may not have session information and be unable to access the social network of the user unless the user is signed in to its social network account. The search engine may check to determine whether the user is currently signed in to the social network account. If the user is signed in and has authorized permission for the search engine to access the social network account, the user may submit queries and receive the URLs that are taggable based on the social network identifier for entities in the user's social network account.

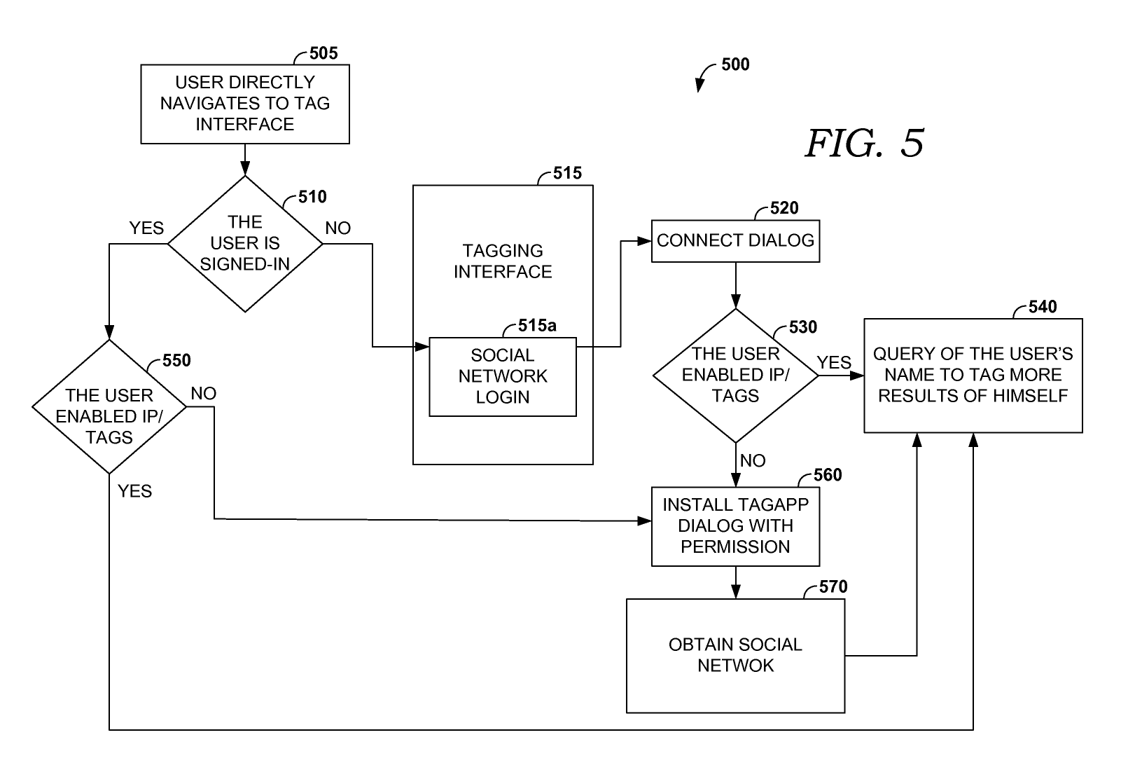

FIG. 5 is a logic diagram that illustrates an exemplary method for providing tags for URLs in the search results page, where the URLs are related to the searcher in accordance with embodiments of the invention. The user may access the tagging interface of the search engine via a URL that lands on the tagging interface, in step 505. The search engine may check to determine whether the user is logged in to a social network account, in step 510.

If the user is not logged in, the search engine may redirect the user to a social network login dialog, in step 515. In one embodiment, the social network dialog is selected by the user in step 515a. The user connects to the social network, in step 520. The user may modify permissions within the social network account to allow portions of the profile to be utilized by the tagging interface. In step 530, the search engine determines whether the social network for the user is accessible. If the search engine is able to access the social network, the user may enter queries and tag results for himself or herself and others, in step 540. If the search engine is unable to access the social network, in step 560, the user may utilize an application and API that enables the search engine to access the social network based on the permission sets by the user. Once the application and API are executed on the user's computer, in step 570, the search engine may obtain the social network of the user. The user may now utilize the social network to identify tags for the URLs of a search engine results page returned in response to a query submitted by the user to the search engine.

If the user is logged in, the search engine checks to determine whether the social network of the user is accessible, in step 550. If the search engine is able to access the social network, the search engine may obtain the social network of the user. And the user may utilize the social network to identify tags for the URLs. If the search engine is unable to access the social network, the user may trigger execution of an application dialog and API dialog that enables the search engine to access the social network based on the permission sets by the user, in step 560. Once the application and API dialogs receive the appropriate authorization from the user's computer, the search engine may obtain the social network of the user in step 570. The user may now utilize the social network to identify tags for the URLs of a search engine results page returned in response to a query submitted by the user to the search engine.

The search engine generates tagging interfaces that allow the user to enter tags, set permissions, access a searcher's social network, and manage tags associated with URLs included in the search results page. The tagging interfaces are graphical and allow the user to visualize the entities on the user's social network that are related to the content of the URL. The search engine utilizes the social network information and tags received from the user to disambiguate the subsequent queries received from the user or other searchers.

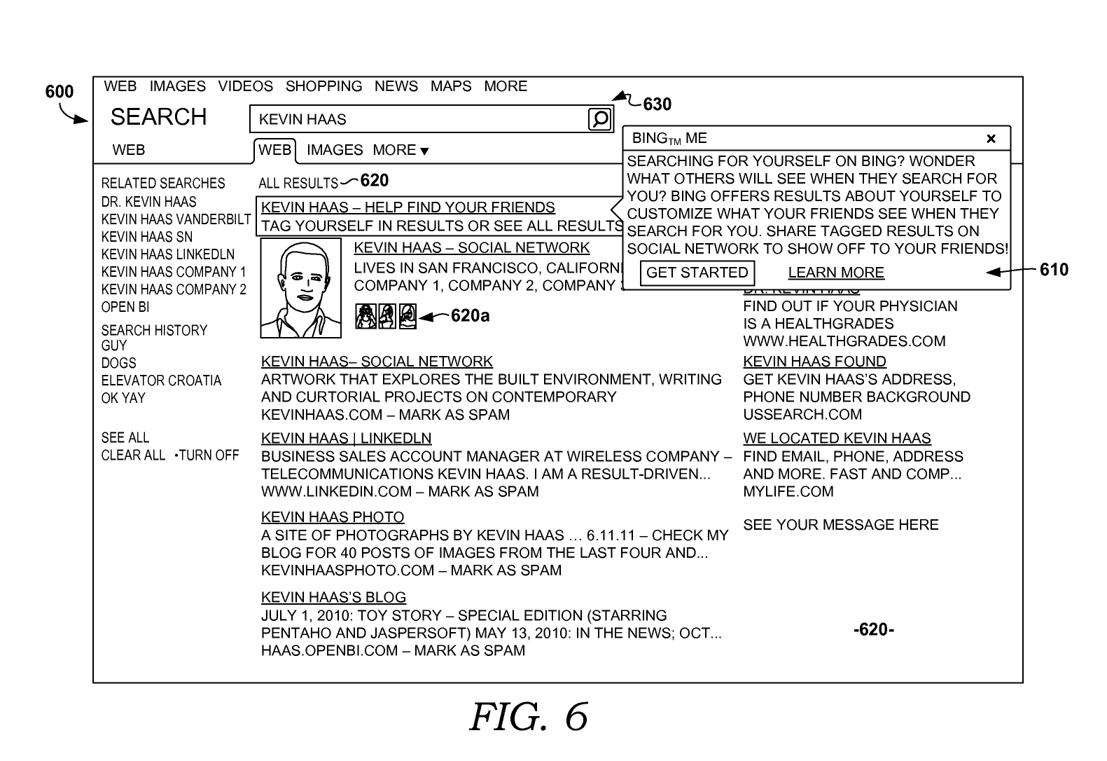

FIGS. 6-25 are schematic diagrams that illustrate an exemplary graphical user interface generated by the search engine as the user performs several of the available tagging actions. FIG. 6 is a schematic diagram that illustrates an exemplary graphical user interface 600 with tag elements of a search engine results page, in accordance with an embodiment of the invention. The search engine, in field 630, may receive a query from a user for Kevin Haas. Because the user is not logged in to a social network, the search engine results page will not include a normal tagging interface. The search engine results pages will include a tag notification 610, the results 620, and some information from a profile of social networks matching the query term. This would be a normal search engine results page generated by the search engine for users that are not logged in to a social network. The tags notification 610 would allow the user to select a social network and begin tagging URLs included in results 620. In some embodiments, the information from the profile of social network matching the query term may include images of friends 620a identified in the matching profile.

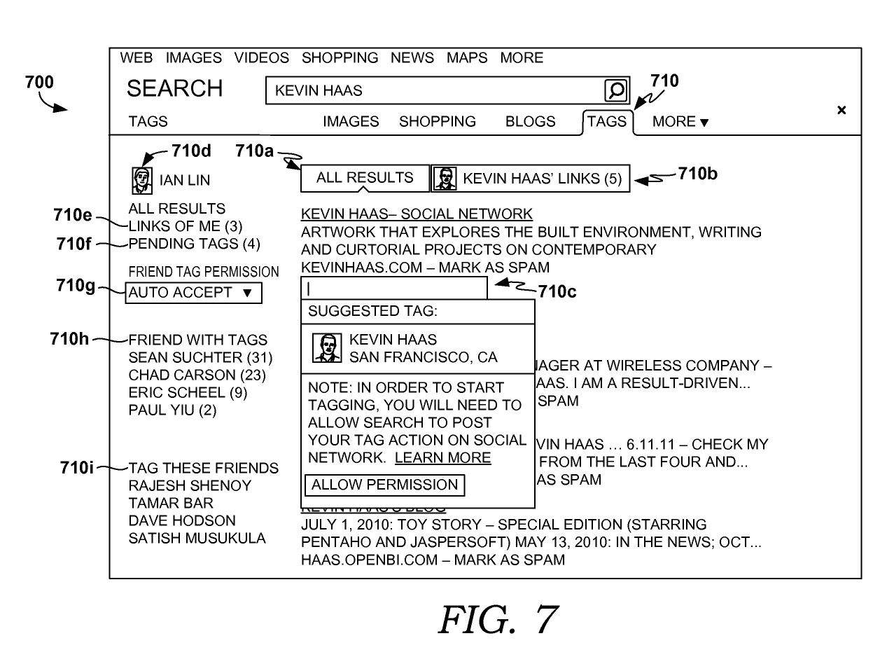

FIG. 7 is a schematic diagram that illustrates an exemplary graphical user interface 700 having tag functionality for URLs in the search engine results page, in accordance with an embodiment of the invention. The search engine may receive a query from a logged-in user, like Ian Lin, for “Kevin Haas.” In one embodiment, the search engine may return a search results page that includes any combination of normal search results, tagged URLs of the logged-in user, and tagged URLs of “Kevin Hass” if Kevin Haas is an entity in the social network of the user.

Because the user is logged in to a social network, the search engine results page may include a tagging interface 710 that allows the user to enter tags. The tagging interface may include a results section 710a, a cluster section 710b, entry field 710c, identifier of the logged-in user 710d, link to tagged URLs of the user 710e, link to URLs requiring approval of the user 710f, the default permission set for the user 710g, tagged friends of the user included in the social network 710h, and friends of the user that may be tagged 710i. The tagged friends of the user included in the social network 710h may include the social network identifier and the number of tag URLs for the entity. In one embodiment, the search engine orders the entities based on the number of tagged URLs. In other embodiments, the entities may be ordered based on the number of mutual friends between the searcher and the entity. The friend of the user that may be tagged 710i may include entities that have not been tagged by the searcher. These entities may be ordered based on the number of mutual friends between the searcher and the entity or number of tagged URLs. In other embodiments, the friend of the user that may be tagged 710i may include entities that have not been tagged by anyone. These entities may be ordered based on the number of mutual friends between the searcher and the entity.

The user may provide the search engine with a tag via entry field 710c. In turn, the search engine may provide auto-complete suggestions to the user based on the entities in the social network of the user that matches the query. In some embodiments, the user must allow the search engine to transmit tagging actions for posting on the user's wall in the social network. If the user does not allow the posting notifications, the user may be unable to tag the URLs included in the search engine results page.

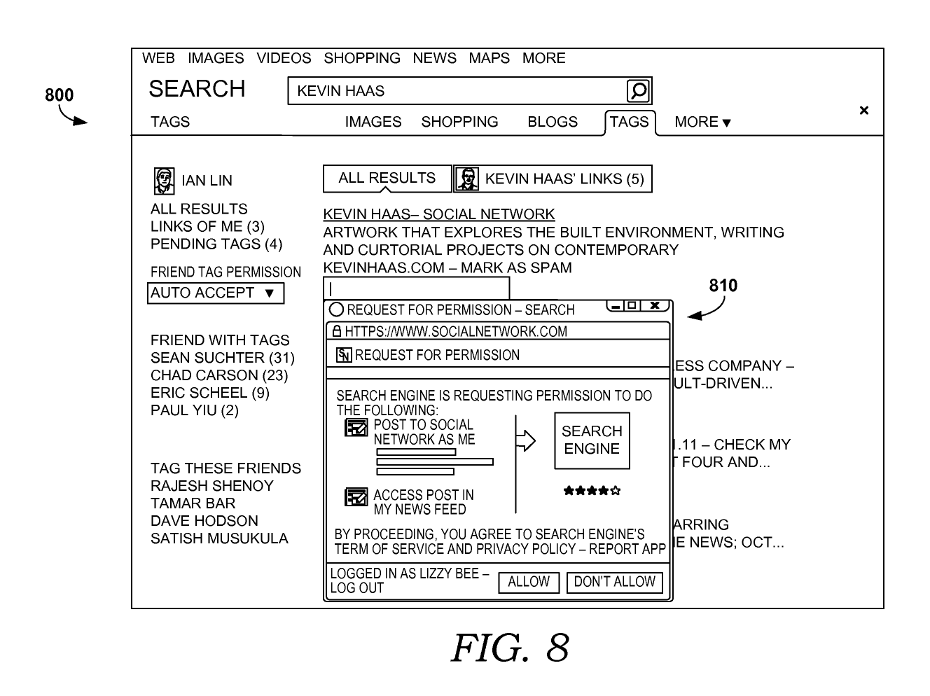

FIG. 8 is a schematic diagram that illustrates an exemplary graphical user interface 800 having functionality to request permission to access a social network, in accordance with an embodiment of the invention. As discussed above, the user must provide the search engine with permission to access a broadcast feed within the social network. The search engine provides permission dialog 810 to have the user authorize the search engine to access a user social network wall and to allow the search engine to post tagging actions to the user's wall.

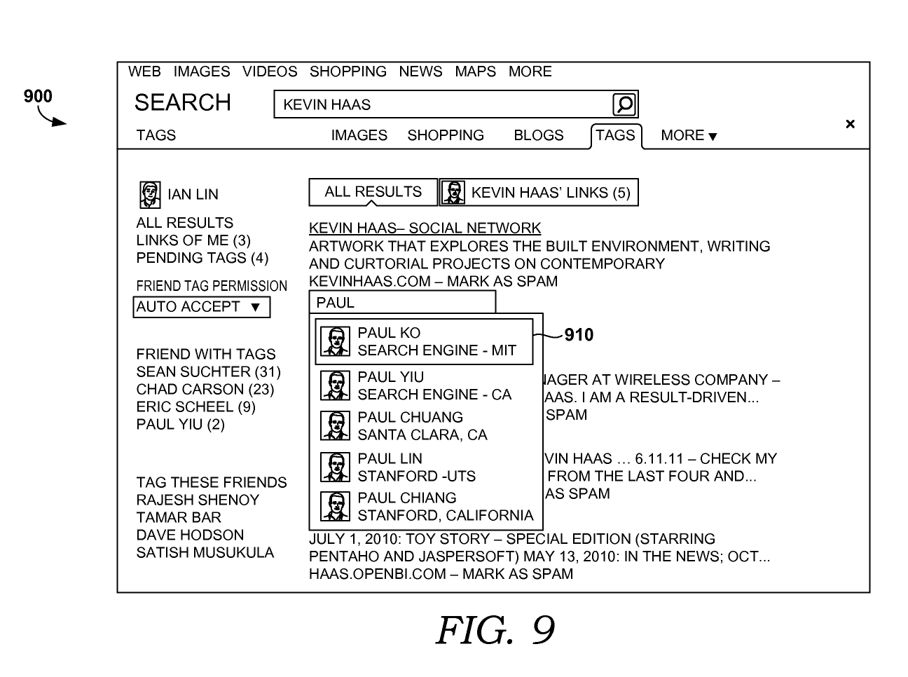

FIG. 9 is a schematic diagram that illustrates an exemplary graphical user interface 900 having functionality to provide tag suggestions based on partial tags, in accordance with an embodiment of the invention. The search engine provides an auto-complete functionality that allows the user to begin typing a tag while the search engine suggests, in a pop-up 910, names from the social network of the user that completes the entry being typed by the user. The search engine is able to access the social network of the user to obtain the possible completions. In some embodiments, the names suggested to the user are for entities that are within a threshold number of hops, e.g. two from the user.

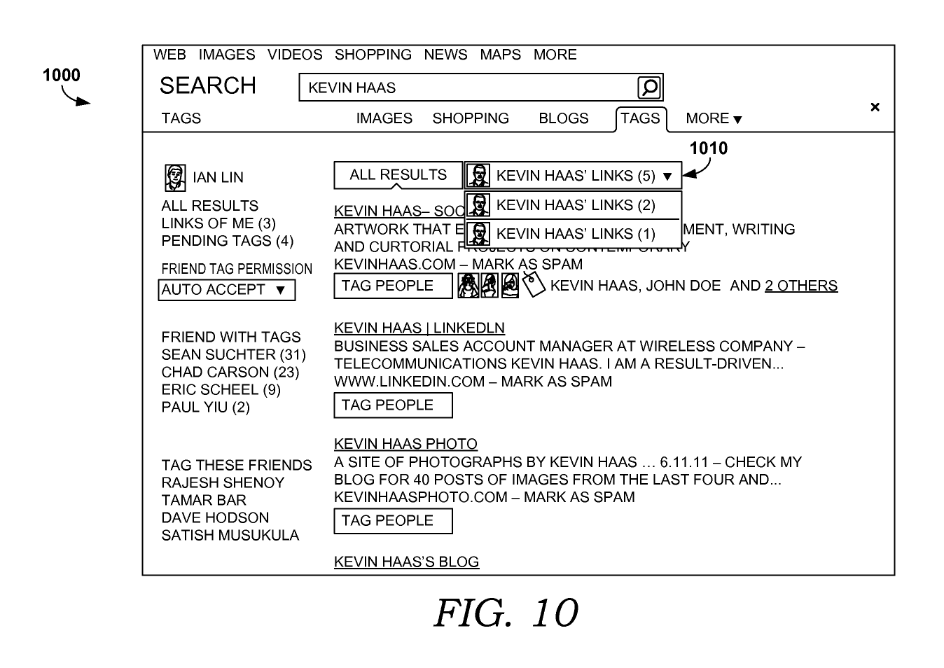

FIG. 10 is a schematic diagram that illustrates an exemplary graphical user interface 1000 having search results and clusters associated with tagged results, in accordance with an embodiment of the invention. The search engine results page may include multiple clusters 1010 when a user has several entities with the same name in the social network of the user. When the user is connected to one or more entities that matches the query and the one or more entities are tagged in one or more URLs, the tagged URLs in the search engine results page are given priority placement, by the search engine, over the other URLs in the search engine results page.

In one embodiment, the clusters 1010 include tagged URLs for each of the different entities. In some embodiments, the clusters may provide an indication of the number of URLs that are tagged for the specific entity. By clicking on the clusters, the search engine loads a page with all the tags for the selected entity. In one embodiment, the clusters 1010 are ordered by the search engine based on the number of tagged URLs associated with the entity. In another embodiment, the clusters 1010 are ordered by the search engine based on the number of mutual friends the selected entity has with the searcher.

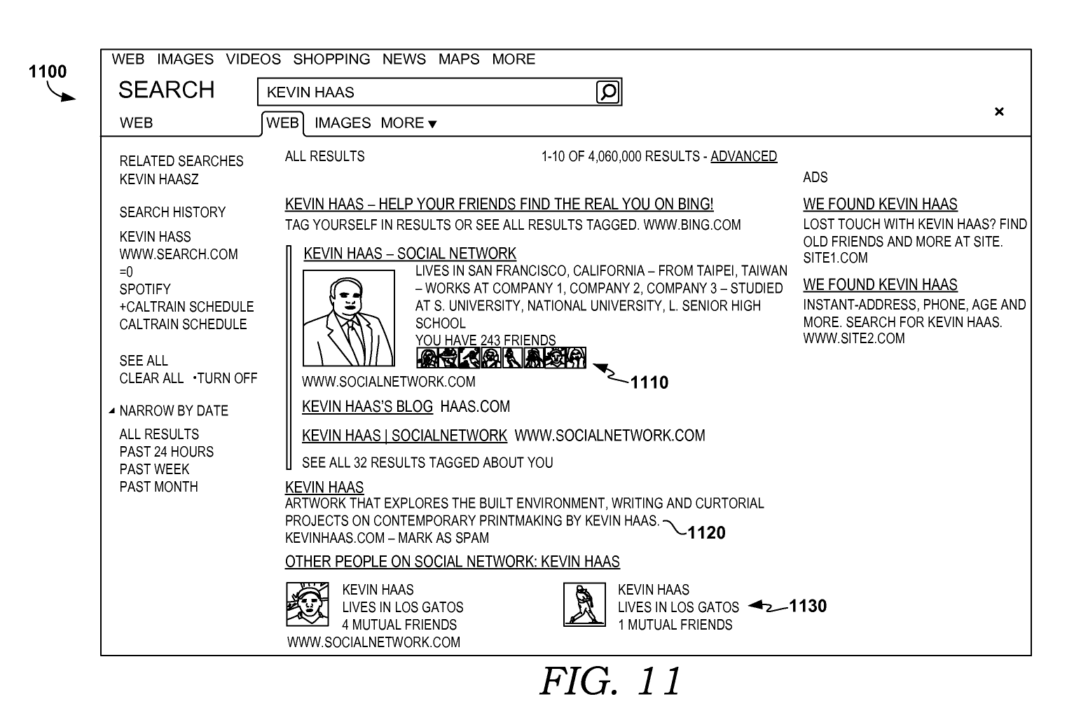

FIG. 11 is a schematic diagram that illustrates an exemplary graphical user interface 1100 having search results for the searcher, in accordance with an embodiment of the invention. The logged-in searcher may be “Kevin Haas” a user of the search engine that is looking for information about himself on the Internet. The search engine results page would include results 1110, 1120, and 1130 that match the query and utilize the social network information of the searcher to determine that the user issued a query for himself or herself. This may allow the search engine to configure a user summary that includes information from the social network, e.g., photograph, education, and work history included in results 1110, 1120, or 1130. The user summary may also include the contacts of the searcher, tagged URLs of the searcher, and the total number of URLs tagged for the user. In one embodiment, the tagged URLs of the searcher include the URLs that are clicked on frequently. The search engine results page may include other results 1120 that match the query. If the user has other entities with the same name their social network information is also displayed to the user in the results 1130. In most embodiments, the search engine will display the profile information of the user searching for himself higher than the other entities that match the query unless the user clicks on a result for another entity with the same name as the user.

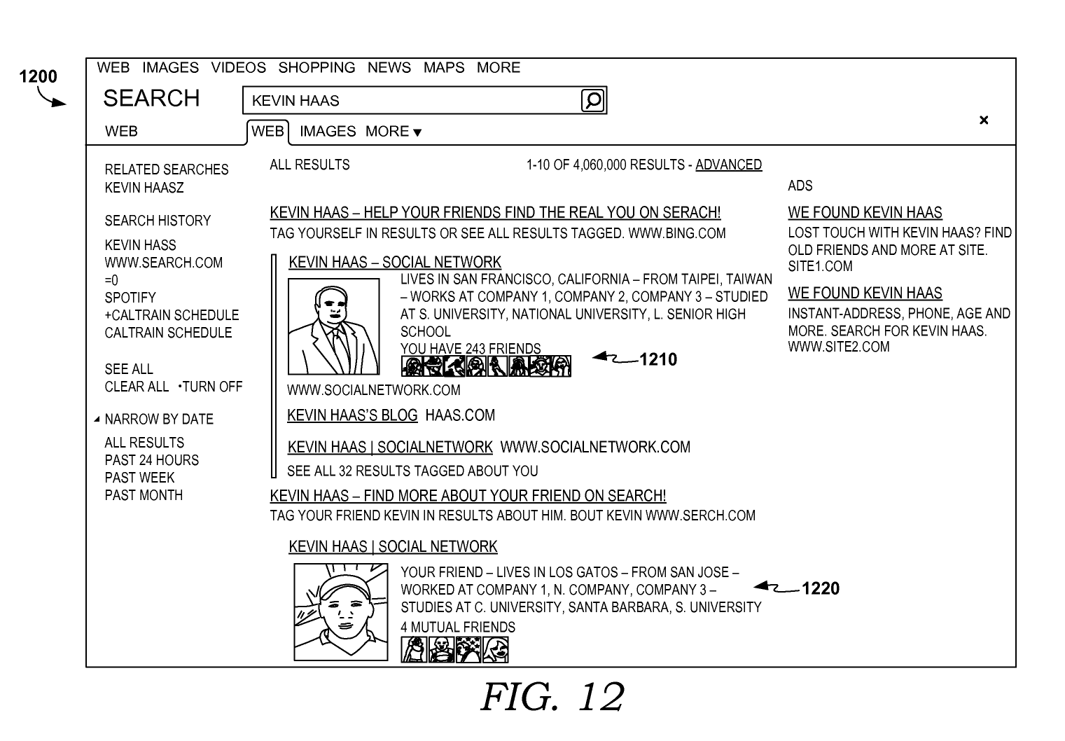

FIG. 12 is a schematic diagram that illustrates an exemplary graphical user interface 1200 having search results for the searcher and other entities with a similar name, in accordance with an embodiment of the invention. After the search engine receives a query for the name of the searcher that is logged in, a self-search, the search engine may generate a search engine results page that is initially limited in scope to the information from the social network of the user and previously tagged results. The results may include profile information for two or more entities 1210, 1220 that match the query. The profile information may include a listing of friends, work location, prior work history, and education. At least one of the entities 1210 or 1220 included in the search engine results page may be the searcher. In one embodiment, the search engine results page is configured to include only the searcher's profile information and the profile information of the entity with the same name that is the fewest number of hops away from the searcher and that has the largest number of mutual friends.

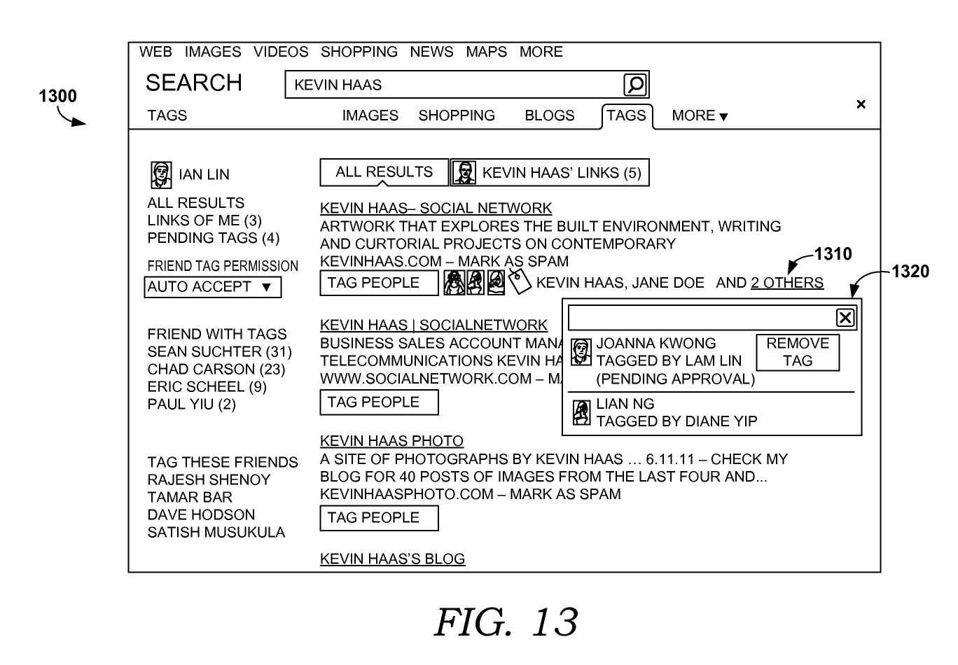

FIG. 13 is a schematic diagram that illustrates an exemplary graphical user interface 1300 having removable tags in the search results, in accordance with an embodiment of the invention. The logged-in user may review tags within the search engine results page. The tags present the entities that have been associated with a URL. The tags may have been previously entered by other searchers or the logged-in user. The tags may be grouped together to save space and replaced with a more available indication 1310, e.g., “2 More” or “More . . . ” that other tags have been associated with a URL. The user may click on, or hover over, the more available indication to reveal the other tags. The other tags and the taggers may be revealed in a dialog box 1320. In some embodiments, if any of the tags were previously entered by the user, the dialog box 1320 may include a remove tag button that allows the user that tagged the URL to remove the tag. In other embodiments, the dialog box 1320 may also include an approval status that informs the user or tagger whether the taggee has approved the tag.

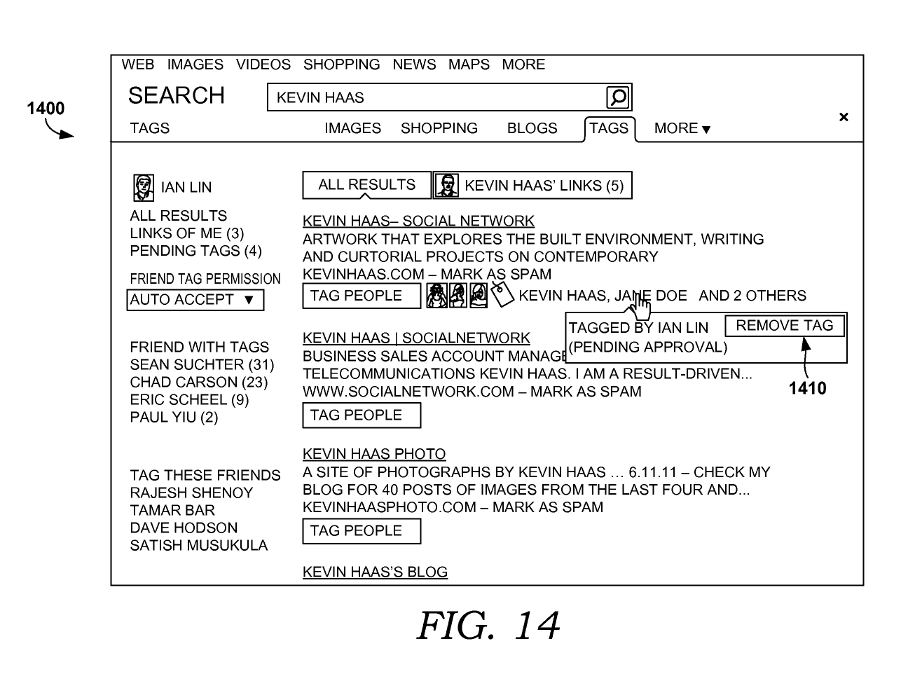

FIG. 14 is a schematic diagram that illustrates an exemplary graphical user interface 1400 having permission status for tags in the search results, in accordance with an embodiment of the invention. As discussed above, the user may click on, or hover over, a tag associated with a URL to reveal the permission status of the tag in a dialog box 1410. For instance, the permission status may indicate that the taggee still needs to approve the tag. The dialog box may include a remove tag button that allows the user that tagged the URL to remove the tag. In some embodiments, the search engine may reveal the social network identifier of the individual that tagged the URL in the dialog box 1410.

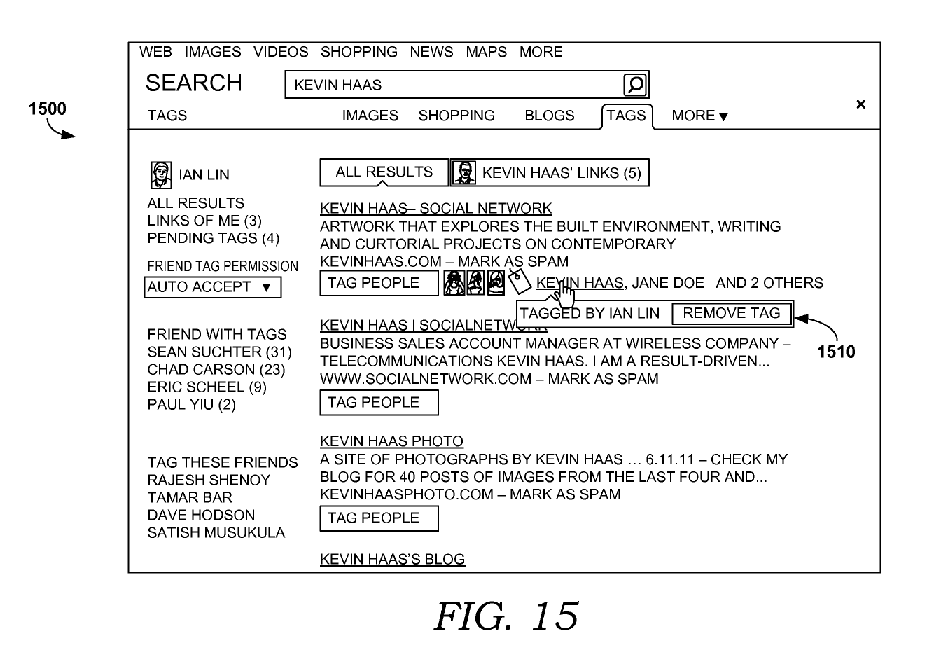

FIG. 15 is a schematic diagram that illustrates another exemplary graphical user interface having removable tags in the search results, in accordance with an embodiment of the invention. In another embodiment, the user may click on, or hover over, a tag associated with a URL to cause the search engine to generate a dialog box 1510. The dialog box 1510 allows the user to remove a tag previously entered by the user regardless of the permission status. For instance, the permission status may indicate that the taggee approved the tag. The dialog box may include a remove tag button that allows the user that tagged the URL to remove the tag. In some embodiments, the search engine is configured to allow either the tagger or the taggee to remove a tagged URL. Any update to tags may also be reflected in the index utilized by the search engine to obtain URLs that match the query.

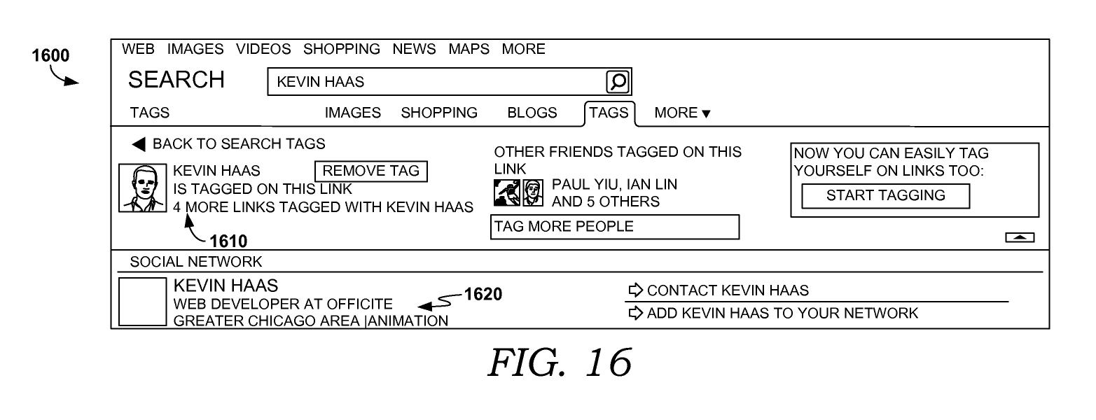

FIG. 16 is a schematic diagram that illustrates an exemplary graphical user interface 1600 having social network profile information associated with a tagged search result, in accordance with an embodiment of the invention. In some embodiments, the search engine may determine that a user has not logged into a social network before providing a query. The user may navigate to a tagging interface without first logging on. The search engine may allow the user to search the tags but return only limited information about the entities included in the query. For instance the social network information 1610 and 1620 may include the number of tags, name of the entity, friends of the entity, and a photograph if the taggee allows use of its social network information.

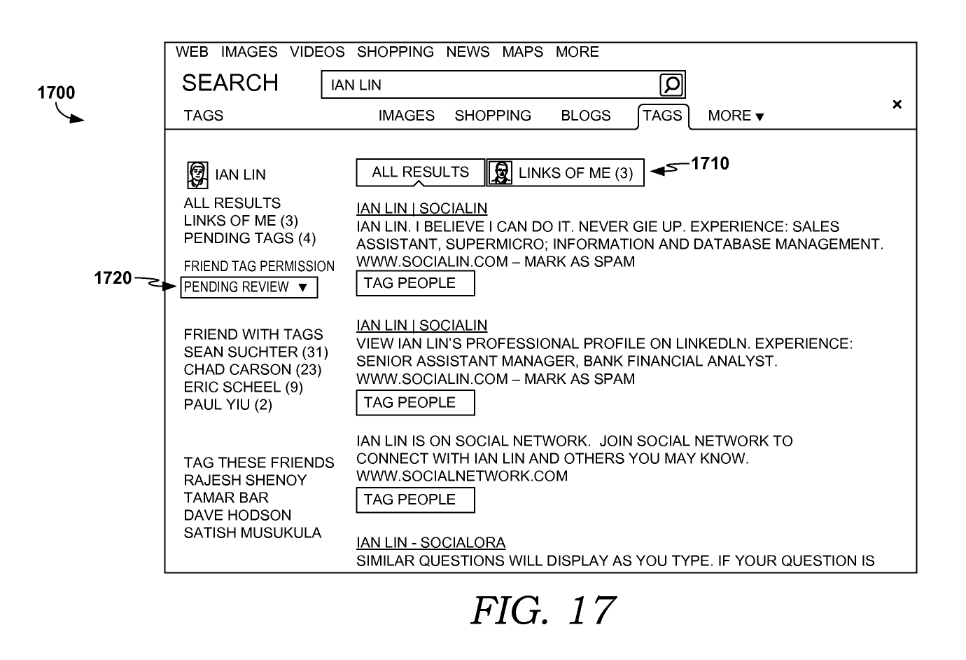

FIG. 17 is a schematic diagram that illustrates an exemplary graphical user interface 1700 having taggable search results for the searcher, in accordance with an embodiment of the invention. As discussed above, the search engine may receive a self-query, where the logged-in user is searching for content about himself or herself. For instance, the user, “Ian Lin,” may submit a self-query to the search engine. In turn, the search engine generates a search engine results page having matches for the query. The search engine may also generate a tagging interface that allows the user to tag URLs having content about the user. The tagging interface may include, among other things, cluster 1710 and permission criteria 1720. The cluster 1710 includes tagged URLs associated with the user and may render the number for tagged URLs to a user. The permission criteria 1720 allows the user to specify permission for tags by other searchers. The permissions may include automatically approved, never approve, or review necessary before approved. The user may select the desired permission setting for the tags via permission criteria 1720.

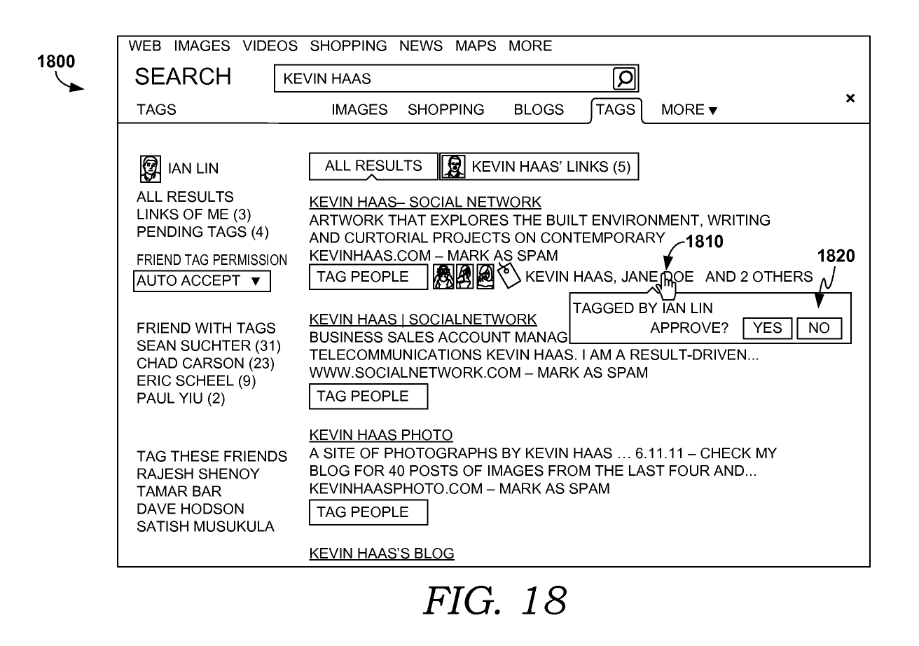

FIG. 18 is a schematic diagram that illustrates an exemplary graphical user interface 1800 having an approval dialog to approve a tag, in accordance with an embodiment of the invention. In one embodiment, the tags 1810 associated are with the result and displayed to the user on the computing device. For instance, a user may click on, or hover over, a tag 1810 to obtain the approval dialog 1820. The search engine may generate an approval dialog 1820 to allow the user to approve the tag.

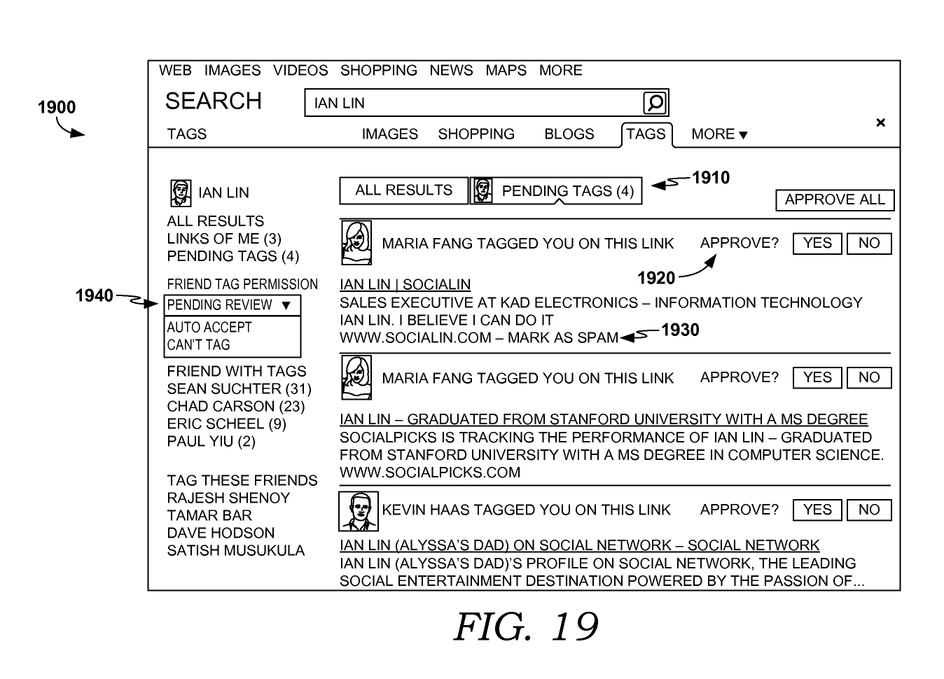

FIG. 19 is a schematic diagram that illustrates an exemplary graphical user interface 1900 having an approval dialog for tags entered by a searcher, in accordance with an embodiment of the invention. In another embodiment, the search engine may present the logged-in user with a tag management interface having all tags that are pending approval. The tag management interface may include a cluster 1910, an approval button 1920, tagged URLs 1930, and the permission criteria 1940. In one embodiment, tagged URLs 1930 are ordered by the search engine based on the date and the time the URL was associated with the tag. The cluster 1910 is a link to pending URLs and includes the number of URLs pending for the user. The approval button 1920 allows the user to individually accept each of the tag-URL pairings suggested by searchers. In some embodiments, the user may utilize an approve-all button to accept all tag-URL pairings suggested by searchers at the same time. When a taggee rejects or removes a tag from the URL the search engine prevents other searchers or taggers from retagging the taggee with the URL. In one embodiment, only the taggee will be able to tag himself with the URL. Accordingly, the search engine allows users to untag documents about themselves which prevents future tagging of these documents.

In some embodiments, the taggee may be able to specify a relationship with a URL. The relationship may include author, contributor, profile, publicity, etc. The relationship may be stored in the index for later retrieval with the tag-URL pair.

The permission criteria 1940 allows the user to specify permission for tags by other searchers. The permissions may include automatically approved, never approve, or review necessary before approved. Any tagged URLs that are not approved will only be visible to the taggee and the tagger. In some embodiments, the permissions may allow the user to block a particular user from tagging the user with URLs included in the search engine results page. In yet another embodiment, the search engine may notify the user via a message notification when additional new URLs, not currently displayed in tagged URLs 1930, are associated with the user.

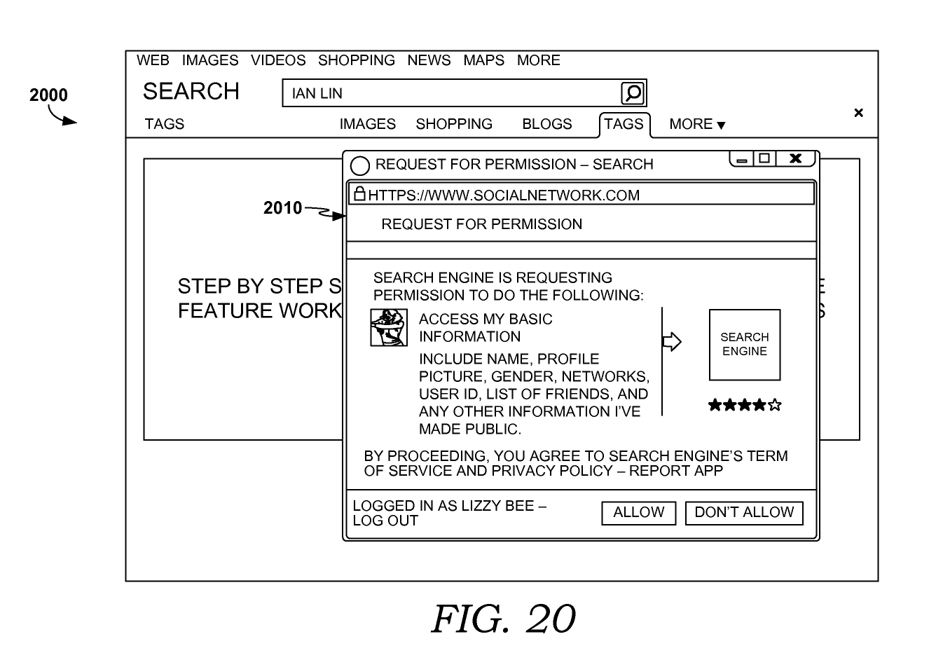

FIG. 20 is a schematic diagram that illustrates another exemplary graphical user interface 2000 having a permission dialog to access a social network of the searcher, in accordance with an embodiment of the invention. In some embodiments, the permission dialog 2010 may be presented to the user when the search engine needs to access social network information for a user that is not logged in to a social network. The search engine utilizes the dialog to obtain permission to access the network and to allow the user to select and connect to a social network.

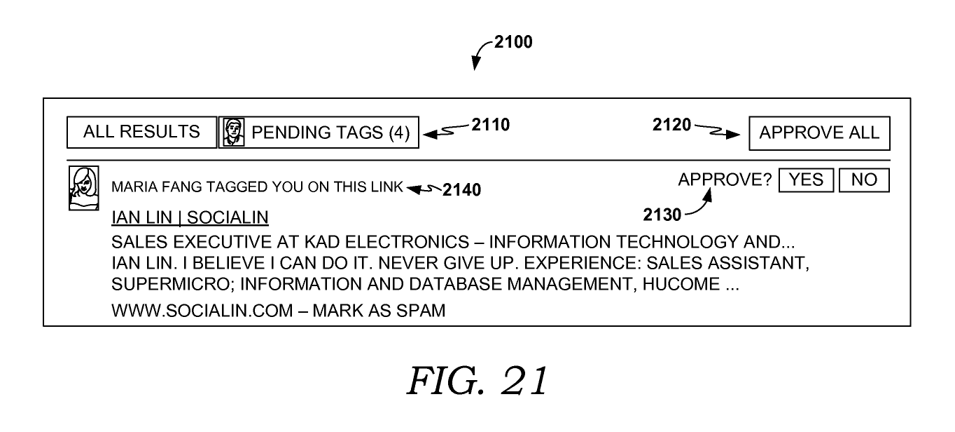

FIG. 21 is a schematic diagram that illustrates another exemplary graphical user interface 2100 having an approval dialog for tags entered by the searcher, in accordance with an embodiment of the invention. In an alternate embodiment, the tag management interface may include a cluster 2110, an approve-all button 2120, an approval button 2130, and the tagged URLs 2140. The cluster 2110 is a link to pending URLs and includes the number of URLs pending for the user. The user may utilize an approve-all button 2120 to accept all tag-URL pairings suggested by the other searchers. The approval button 2130 allows the user to accept each of the tag-URL pairings suggested by searchers, individually. The tagged URLs provide information, e.g., a social network identifier, of the searcher that tagged the URLs and the URL that has content related to the user.

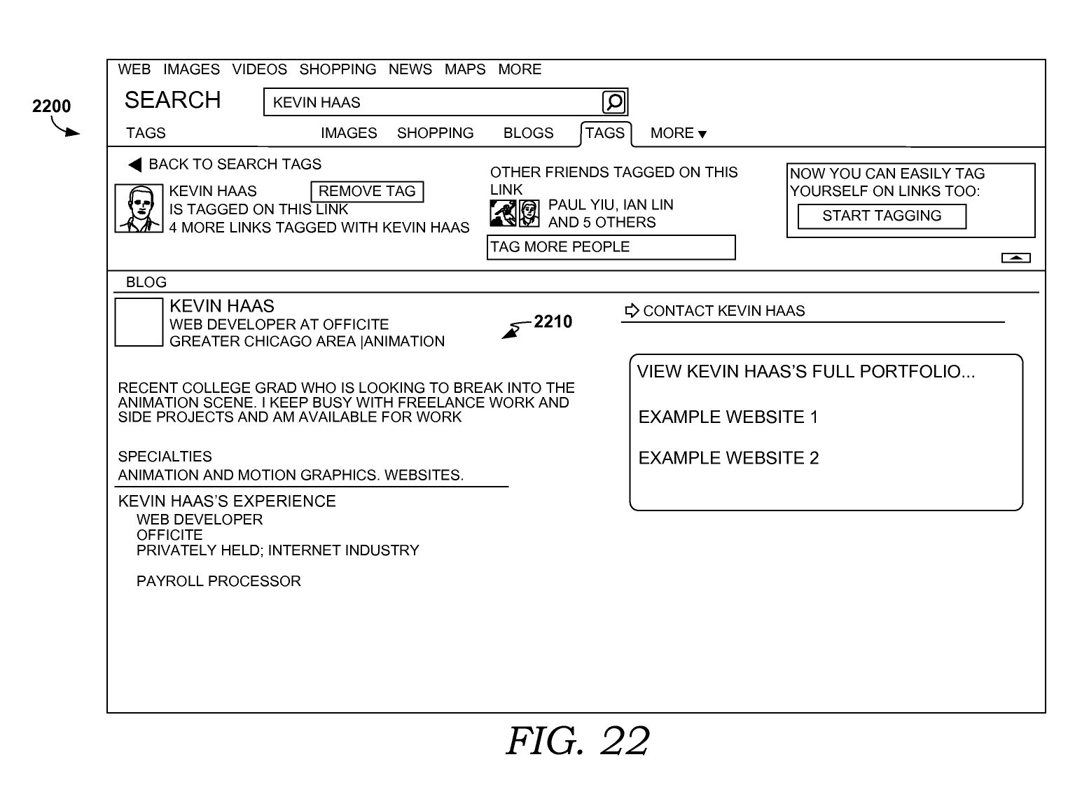

FIG. 22 is a schematic diagram that illustrates another exemplary graphical user interface 2200 having a tagged search result, in accordance with an embodiment of the invention. In one embodiment, the search engine may provide the user with information for an entity tagged by the user and located in the user's social network. The search engine may provide a detailed view 2210 of the tagged URL. In one embodiment, the detailed view 2210 may be provided to the user in an interactive frame. For instance, the tagged URL may be included in the tag interface as an interactive frame. The interactive frame allows the tagged URL to be loaded and navigated while the user performs tagging of URLs in the search engine results page.

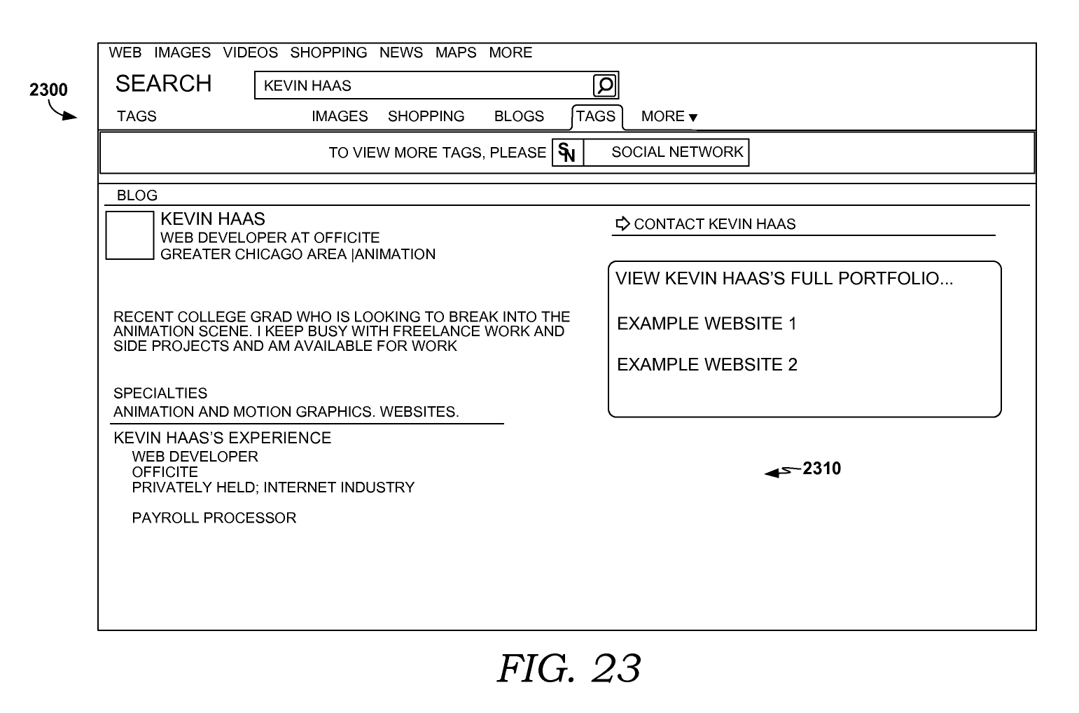

FIG. 23 is a schematic diagram that illustrates an exemplary graphical user interface 2300 without tagged search results, in accordance with an embodiment of the invention. As discussed above, the detailed view 2310 may provide the user with a view of the content associated with a URL included in the search results. The detailed view 2310 is available for users that are not logged in. For instance, the content of the URL is included in an interactive frame.

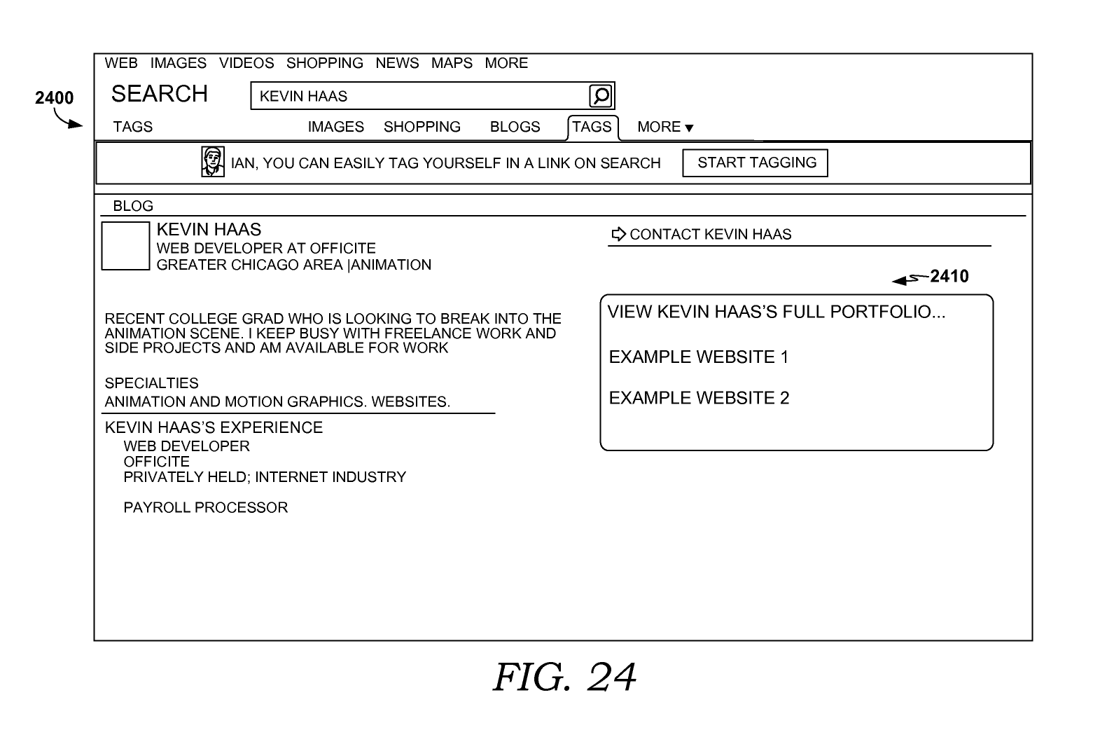

FIG. 24 is a schematic diagram that illustrates another exemplary graphical user interface 2400 having a result for a logged-in searcher, in accordance with an embodiment of the invention. As discussed above, the detailed view 2410 may include tagged results associated with the logged-in user. For instance, the tagged URL may be viewed within an interactive frame. The interactive frame allows the user to navigate the content of the tagged URL while the user tags himself or herself and friends in URLs of the search engine results page. The URLs may be tagged with entities included in the social network information of the user. In one embodiment, when the user is logged in but isn't a friend of the taggee, the user will be unable to tag the result. Additionally, other tagged URLs for the taggee may not be made available to the user unless the user is a friend, i.e., within n hops of the user, where n is whole number greater than 0. In at least some embodiments, n may be one, two, or three.

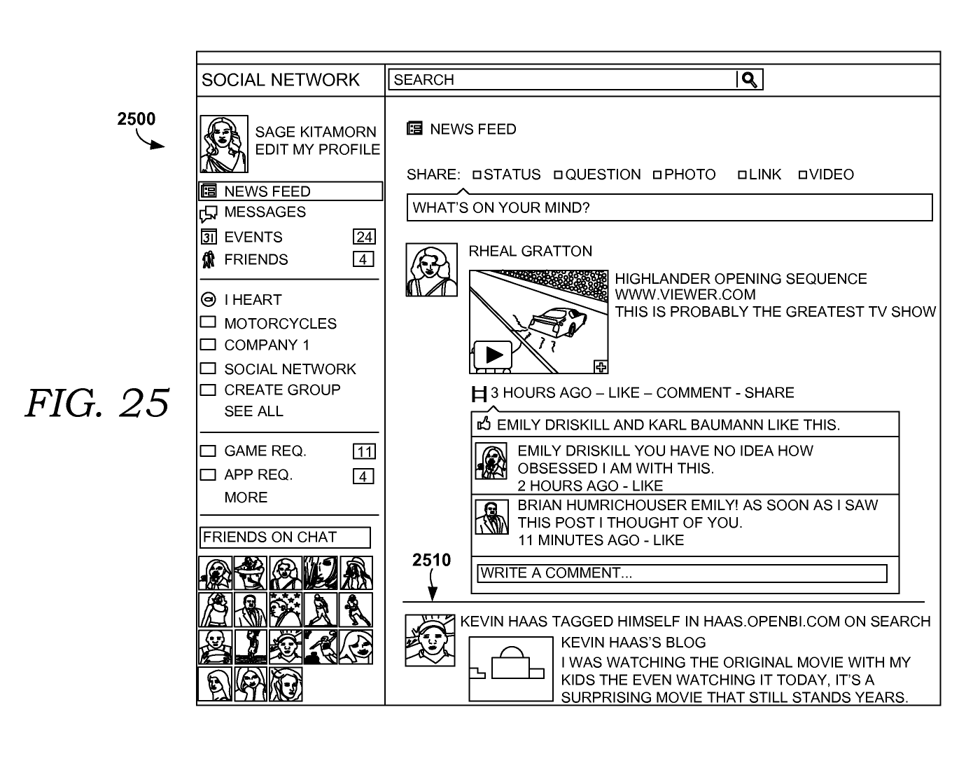

FIG. 25 is a schematic diagram that illustrates another exemplary graphical user interface 2500 having a feed in a social network application associated with a searcher, in accordance with an embodiment of the invention. The search engine may transmit a feed 2510 to a broadcast channel or wall of the social network of the searcher. The feed 2510 may include the social network identifier of the taggee, tagger, and the one or more URLs. In some embodiments, the feed 2510 may be broadcast to each user in the taggers social network. In other embodiments, the feed 2510 may be broadcast to each user in the taggee's social network. The feed 2510 may be a link to the tagging interface having the tagged URLS for the entity associated with the tagged URLs. Accordingly, entities within the social network of the taggee may click on the link in the feed 2510 and the social network application will send the entities to the search engine, which generates the tagging interface for the entities.

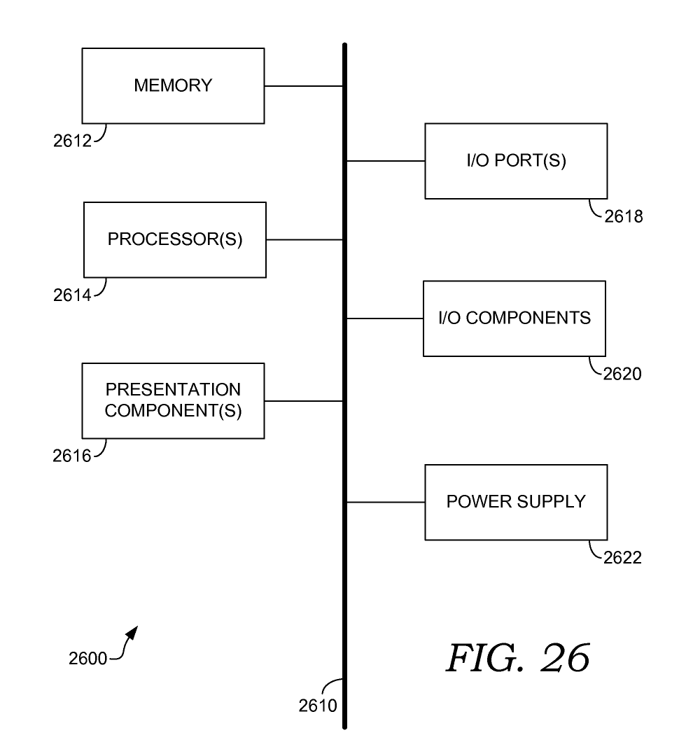

Having briefly described embodiments of the invention, an exemplary operating environment in which embodiments of the invention may be implemented is described below in order to provide a general context for various aspects of the present invention. Referring to the figures in general and initially to FIG. 26 in particular, an exemplary operating environment for implementing embodiments of the present invention is shown and designated generally as computing device 2600. The computing device 2600 is but one example of a suitable computing environment and is not intended to suggest any limitation as to the scope of use or functionality of embodiments of the invention. Neither should the computing device 2600 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like refer to code that performs particular tasks or implements particular abstract data types. Embodiments of the invention may be practiced in a variety of system configurations, including hand held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 26, the computing device 2600 includes a bus 2610 that directly or indirectly couples the following devices: a memory 2612, one or more processors 2614, one or more presentation components 2616, input/output (I/O) ports 2618, I/O components 2620, and an illustrative power supply 2622. The bus 2610 represents what may be one or more busses (such as an address bus, data bus, or combination thereof). Although the various blocks of FIG. 26 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 26 is merely illustrative of an exemplary computing device that can be used in connection with one or more embodiments of the present invention. Distinction is not made between such categories as “workstation,” “server,” “laptop,” “hand held device,” etc., as all are contemplated within the scope of FIG. 26 and reference to “computing device.”

The computing device 2600 typically includes a variety of computer-readable media. Computer-readable media can be any available media that can be accessed by the computing device 2600 and includes both volatile and nonvolatile media, removable and non-removable media implemented in any method or technology for storage of information such as computer-readable instructions, data structures, program modules, or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above are also included within the scope of computer-readable media.

The memory 2612 includes computer-storage media in the form of volatile and/or nonvolatile memory. The memory may be removable, nonremovable, or a combination thereof. Exemplary hardware devices include solid-state memory, hard drives, optical-disc drives, and the like. The computing device 2600 includes one or more processors that read data from various entities such as the memory 2612 or the I/O components 2620. The presentation component(s) 2616 present data indications to a user or other device. Exemplary presentation components include a display device, speaker, printing component, vibrating component, and the like.

The I/O ports 2618 allow the computing device 2600 to be logically coupled to other devices including the I/O components 2620, some of which may be built in. Illustrative components include a microphone, joystick, game pad, satellite dish, scanner, printer, wireless device, and the like.

As previously mentioned, embodiments of the invention are generally directed to systems, methods, and computer-readable storage media for, among other things, presenting social network connections in association with a search engine results page. Upon receipt of a search query, it is determined if the query, or a portion thereof, is a name query. It is also determined if social networking data associated with the user is available. If it is determined that at least a portion of the query is a name query and that a social network associated with the user is available, the name query is compared to the social network to determine if there is an entity that matches the query. If it is determined that one or more entities match the name query, information about the matching entities are presented as potential tags for URLs in the search engine results page generated by the search engine in response to the received query. Embodiments of the invention further permit the user, taggers, or taggees to specify permission for accessing the social network and utilizing broadcast feeds to inform the entities of the tags created by a searcher within their social network.

The foregoing descriptions of the embodiments of the invention are illustrative, and modifications in configuration and implementation are within the scope of the current description. For instance, while the embodiments of the invention are generally described with relation to the figures, those descriptions are exemplary. Although the subject matter has been described in language specific to structural features or methodological acts, it is understood that the subject matter defined in the appended claims is not necessarily limited to the specific features or acts described above. Rather, the specific features and acts described above are disclosed as example forms of implementing the claims. The scope of the embodiment of the invention is accordingly intended to be limited only by the following claims.

1. A computer-implemented method to tag entities included in search results, the method comprising:
receiving, by a server device, a query that includes a name of an entity;
searching, by the server device, an index to locate URLs associated with content that matches the name;
returning, by the server device, search results that include the name;
providing, by the server device, an interface where the user enters tags for one or more URLS included in the search results, wherein providing, by the server device, the interface where the user enters tags for one or more URLS included in the search results further comprises:
obtaining a graph representing the social network of the user that provided the query,
locating entities in the social network that are within a threshold number of hops, and
providing the located entities as suggested tags for the one or more URLs included in the search results based on tagging permissions associated with the entities that allow the users to tag search results with the entities' tags;
and
receiving, by the server device, the tags entered in the interface for storage, wherein the tags identify entities in the social network of the user that provided the query.

2. The computer-implemented method of claim 1, further comprising: generating notifications for one or more social network accounts associated with the entities identified by the tags entered by the user for the one or more URLs.

3. The computer-implemented method of claim 2, further comprising: transmitting the notifications to the one or more social network accounts.

4. The computer-implemented method of claim 3, wherein the notifications include requests to obtain permission from the entities associated with the tags corresponding to the one or more URLs.

5. The computer-implemented method of claim 3, wherein the notifications allow the owners of the social network accounts to authorize the tags or to remove the tags.

6. The computer-implemented method of claim 1, wherein the tags are associated with social network identifiers for entities included in the social network of the user.

7. (canceled)

8. The computer-implemented method of claim 1, wherein the threshold number of hops is three.

9. The computer-implemented method of claim 1, further comprising: updating the storage to include the tags received from the user, wherein subsequent queries for a tagged entity returns the search results that match the subsequent query and a cluster having the URLs that are tagged by the user.

10. The computer-implemented method of claim 9, wherein the cluster includes profile information provided by the social network account of the tagged entity.

11. The computer-implemented method of claim 9, wherein the cluster is a link.

12. The computer-implemented method of claim 11, wherein the link is an image retrieved from the social network account corresponding to the tags.

13. A computer system configured to generate a graphical user interface for tagging search results, the computer system comprising:
a processor configured to receive a query from a user, to transmit the query to a search engine, and receive search results that satisfy the query, wherein the query includes a name of an entity;
a display configured to render a graphical user interface having the search results and entry fields for one or more tags from a social network associated with the user, wherein the user enters the one or more tags for one or more URLs in the search results based on tagging permissions set by the entities associated with the one or more tags; and
the processor transmits the tags to the search engine for storage in a database associated with the search engine, wherein the social network is received from a location specified by the user and the one or more tags are selected from the entities within the social network of the user.

14. The computer system of claim 13, wherein subsequent queries for the name of the entity receives search results that include one or more clusters having the tagged URLs.

15. The computer system of claim 14, wherein the one or more clusters included in the search results are displayed to the user and other potential searchers that are in the social network of the user.

16. The computer system of claim 14, wherein the one or more clusters are available to any user that sends a query for the entity to the search engine.

17. The computer system of claim 13, wherein the location of the social network is a database specified by the user.

18. The computer system of claim 13, wherein the tags are displayed to the user with the search results.

19. One or more computer-readable storage memories storing computer-useable instructions that, when executed by one or more computing devices, cause the one or more computing devices to perform a method to tag entities included in search results, the method comprising:
receiving, by the one or more computing devices, a query that includes a name of an entity;
searching, by the one or more computing devices, an index to locate URLs associated with content that matches the name;
returning, by the one or more computing devices, search results that include the name;
providing, by the one or more computing devices, an entry field where the user enters tags for one or more URLS included in the search results; and
receiving, by the one or more computing devices, the tags entered in the entry field for storage, wherein the tags identify entities in a social network of the user that provided the query, the entities identified by the tags are within a threshold number of hops of the user that provided the query and tagging permissions set by the entities of the social network allow tagging by the user.

20. The memories of claim 19, wherein and subsequent queries for a tagged entity returns the search results that match the subsequent query and tagged URLs that are available to the user.

21. The computer-implemented method of claim 1, wherein the permissions prevent the user and specified entities from tagging search results or the permissions allow tags that are private by limiting visibility of the tags to search results having the tagged URLs and the search results are provided in response to a request that returns the search results to entities in the social network of the tagged entities corresponding to the selected tags.
